(19) United States
(12) Patent Application Publication
(10) Pub. No.: US 2006/0125813 A1
(43) Pub. Date: Jun. 15, 2006

(54) Active matrix liquid crystal display with black-inserting circuit

(75) Inventors: Sz Hsiao Chen, Miao-Li (TW); Long Kuan Chen, Miao-Li (TW); Hung Yu Chen, Miao-Li (TW); Tsau Hua Hsieh, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/317,176

(22) Filed: Dec. 23, 2005

(30) Foreign Application Priority Data
Dec. 14, 2004 (TW) 93140430

(51) Int. Cl. G09G 5/00

(52) U.S. Cl. 345/204

(57) ABSTRACT

An active matrix LCD (200) includes: a plurality of scanning lines (23) that are parallel to each other and that each extend along a first direction; a plurality of signal lines (24) that are parallel to each other and that each extend along a second direction orthogonal to the first direction; a plurality of thin film transistors (TFTs) each provided in the vicinity of a respective point of intersection of the scanning lines and the signal lines; a plurality of scanning line driving circuits (21) for providing a plurality of scanning signal groups to the scanning lines, each scanning signal group including an image scanning signal and a black-inserting scanning signal; a plurality of signal line driving circuits (22) for providing gradation voltage data to the signal lines; and a black-inserting circuit (28) for providing black-inserting signals corresponding to black image data to the signal lines.

### FIELD OF THE INVENTION

The present invention relates to liquid crystal displays (LCDs), and particular to an active matrix type LCD which is suitable for motion picture display.

### BACKGROUND

Because LCD devices have the advantages of portability, low power consumption, and low radiation, they have been widely used in various portable information products such as notebooks, personal digital assistants (PDAs), video cameras, and the like. Furthermore, LCD devices are considered by many to have the potential to completely replace CRT (cathode ray tube) monitors and televisions.

FIG. 3 is an abbreviated circuit diagram of a conventional active matrix LCD. The active matrix LCD 100 includes a glass first substrate (not shown), a glass second substrate (not shown) facing the first substrate, a liquid crystal layer (not shown) sandwiched between the first substrate and the second substrate, a plurality of scanning line driving circuits 11, a plurality of signal line driving circuits 12, and a timing control circuit 16.

The first substrate includes a number n (where n is a natural number) of scanning lines 13 that are parallel to each other and that each extend along a first direction, and a number m (where m is also a natural number) of signal lines 14 that are parallel to each other and that each extend along a second direction orthogonal to the first direction. The first substrate also includes a plurality of thin film transistors (TFTs) 15 that function as switching elements. The first substrate further includes a plurality of pixel electrodes 151 formed on a surface thereof facing the second substrate. Each TFT 15 is provided in the vicinity of a respective point of intersection of the scanning lines 13 and the signal lines 14.

Each TFT 15 includes a gate electrode, a source electrode, and a drain electrode. The gate electrode of each TFT 15 is connected to the corresponding scanning line 13. The source electrode of each TFT 15 is connected to the corresponding signal line 14. The drain electrode of each TFT 15 is connected to a corresponding pixel electrode 151.

The second substrate includes a plurality of common electrodes 152 opposite to the pixel electrodes 151. In particular, the common electrodes 152 are formed on a surface of the second substrate facing the first substrate, and are made from a transparent material such as ITO (Indium-Tin Oxide) or the like. A pixel electrode 151, a common electrode 152 facing the pixel electrode 151, and liquid crystal molecules of the liquid crystal layer sandwiched between the two electrodes 151, 152 cooperatively define a single pixel unit.

The scanning lines 13 are connected to corresponding scanning line driving circuits 11. The signal lines 14 are connected to corresponding signal line driving circuits 12.

FIG. 4 is an abbreviated timing chart illustrating operation of the active matrix LCD 100. The clock signal and the start signal STV1 are generated by the timing control circuit 16. The scanning signals G1.1-Gn.256 are generated by the plurality of scanning line driving circuits 11, and are applied to the scanning lines 13. The enable signal for signal line driving circuit S1.OE-Sk.OE is used to select one of the signal line driving circuits 16 to be in an on state each time. The gradation voltage data VD are generated by the plurality of signal line driving circuits 12, and are sequentially applied to the signal lines 14. The common voltage Vcom is applied to all of the common electrodes 152. Only one scanning signal pulse 19 is applied to each scanning line 13 during each one scan, the scanning signal pulse 19 having a duration equal to one period of the clock pulses. The scanning signal pulses 19 are output sequentially to the scanning lines 13.

Referring to FIGS. 3 and 4, the scanning line driving circuits 11 sequentially provide scanning pulses (G1.1 to Gn.256) to the scanning lines 13, and activate the TFTs 15 respectively connected to the scanning lines 13. When the scanning lines 13 are thus scanned, the signal line driving circuits 12 output gradation voltage data (VD) corresponding with image data of an external circuit to the signal lines 14. Then the gradation voltage data are applied to the pixel electrodes 151 via the activated TFTs 15. The potentials of the common electrodes 152 are set at a uniform potential. The gradation voltage data written to the pixel electrodes 151 are used to control the amount of light transmission of the corresponding pixel units and consequently provide an image display for the active matrix LCD 100.

In FIG. 4, the gradation voltage data VD is a signal whose strength varies in accordance with each piece of image data, whereas the common voltage Vcom is a signal that has a constant value which does not vary at all.

If motion picture display is conducted on the active matrix LCD 100, problems of poor image quality may occur. For example, the residual image phenomenon may occur because the response speed of the liquid crystal molecules is too slow. In particular, when a gradation variation occurs, the liquid crystal molecules are unable to track the gradation variation within a single frame period, and instead produce a cumulative response during several frame periods. Consequently, considerable research is being conducted with a view to developing various high-speed response liquid crystal materials as a way of overcoming this problem.

Further, the aforementioned problems such as the residual image phenomenon are not caused solely by the response speed of the liquid crystal molecules. For example, when the displayed image is changed in each frame period (the period that the scanning line driving circuits 11 sequentially complete scanning from G1.1 to Gn.256 once) to display the motion picture, the displayed image of one frame period remains in a viewer's eyes as an afterimage, and this afterimage overlaps with the viewer's perception of the displayed image of the next frame period. This means that from the viewpoint of a user, the image quality of the displayed image is impaired.

It is desired to provide an active matrix LCD that can overcome the above-described deficiencies.

### SUMMARY

An active matrix liquid crystal display includes: a plurality of scanning lines that are parallel to each other and that each extend along a first direction; a plurality of signal lines that are parallel to each other and that each extend along a second direction orthogonal to the first direction; a plurality of thin film transistors (TFTs) each provided in the vicinity of a respective point of intersection of the scanning lines and the signal lines; a plurality of scanning line driving circuits for providing a plurality of scanning signal groups to the scanning lines, each of the scanning signal groups including an image scanning signal and a black-inserting scanning signal; a plurality of signal line driving circuits for providing gradation voltage data to the signal lines when an image scanning signal is provided to the scanning lines by the scanning line driving circuits; and a black-inserting circuit for providing black-inserting signals corresponding to black image data to the signal lines when black-inserting scanning signals are provided to the scanning lines by the scanning line driving circuits.

Other advantages and novel features will become more apparent from the following detailed description when taken in conjunction with the accompanying drawings, in which:

### BRIEF DESCRIPTION OF THE DRAWINGS

FIG. 1 is an abbreviated circuit diagram of an active matrix LCD according to an exemplary embodiment of the present invention;

FIG. 2 is an abbreviated timing chart illustrating operation of the active matrix LCD of FIG. 1;

FIG. 3 is an abbreviated circuit diagram of a conventional active matrix LCD; and

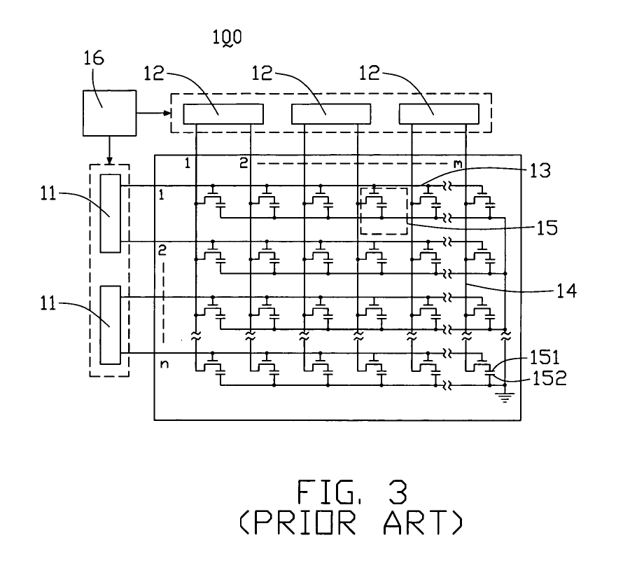

FIG. 4 is an abbreviated timing chart illustrating operation of the active matrix LCD of FIG. 3.

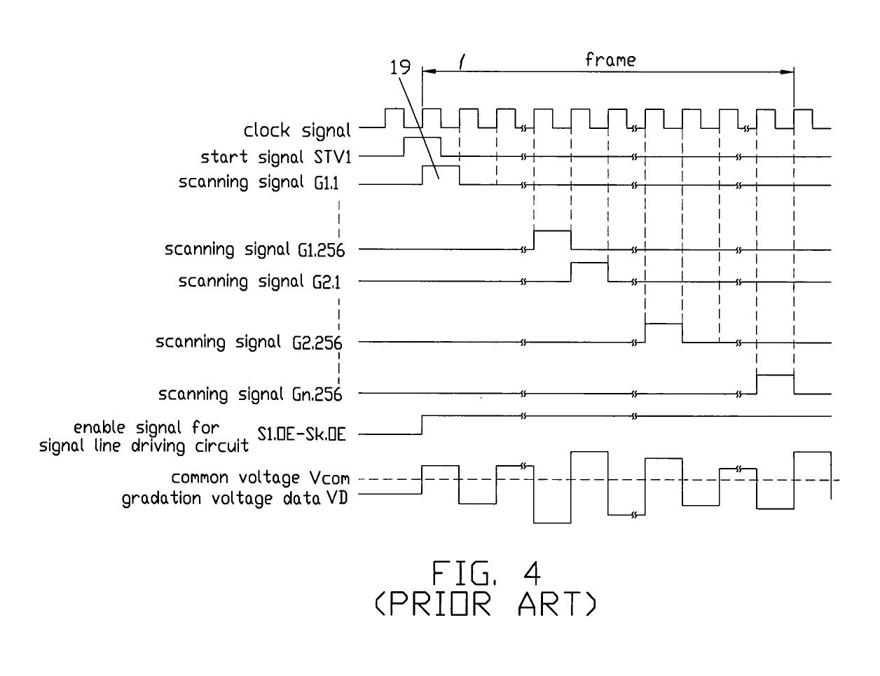

### DETAILED DESCRIPTION OF PREFERRED EMBODIMENTS

Reference will now be made to the drawings to describe the present invention in detail.

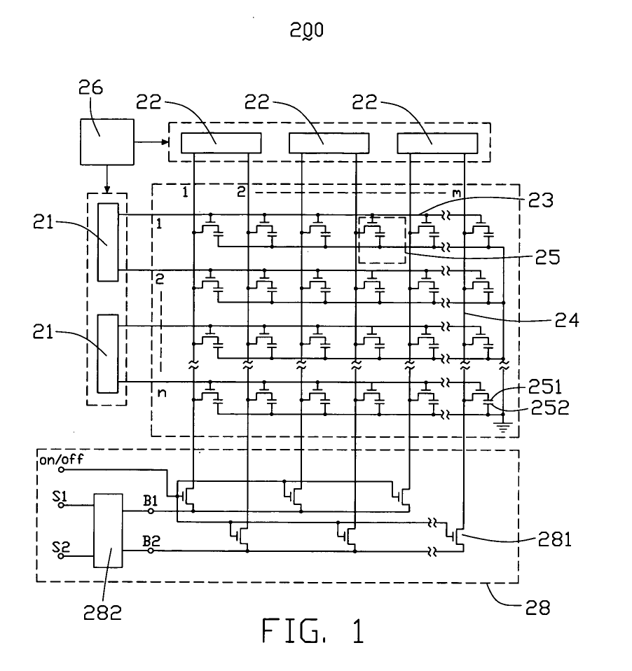

FIG. 1 is an abbreviated circuit diagram of an active matrix LCD according to an exemplary embodiment of the present invention. The active matrix LCD 200 includes a glass first substrate (not shown), a glass second substrate (not shown) facing the first substrate, a liquid crystal layer (not shown) sandwiched between the first substrate and the second substrate, a plurality of scanning line driving circuits 21, a plurality of signal line driving circuits 22, a black-inserting circuit 28, and a timing control circuit 26.

The first substrate includes a number n (where n is a natural number) of scanning lines 23 that are parallel to each other and that each extend along a first direction, and a number m (where m is also a natural number) of signal lines 24 that are parallel to each other and that each extend along a second direction orthogonal to the first direction. The first substrate also includes a plurality of TFTs (thin film transistors) 25 that function as switching elements. The first substrate further includes a plurality of pixel electrodes 251 formed on a surface thereof facing the second substrate. Each TFT 25 is provided in the vicinity of a respective point of intersection of the scanning lines 23 and the signal lines 24.

The signal lines 24 are connected to the signal line driving circuits 22. The scanning lines 23 are connected to the scanning line driving circuits 21. The quantity of the scanning line driving circuits 21 is x (x is a natural number), and each scanning line driving circuit 21 is connected to two-hundred-fifty-six scanning lines. Thus the number n and x content a formula: n=256·x

Each TFT 25 includes a gate electrode (not labeled), a source electrode (not labeled), and a drain electrode (not labeled). The gate electrode is connected to a corresponding one of the scanning lines 23. The source electrode is connected to a corresponding one of the signal lines 24. The drain electrode is connected to a corresponding one of the pixel electrodes 251.

The second substrate includes a plurality of common electrodes 252 opposite to the pixel electrodes 251. In particular, the common electrodes 252 are formed on a surface of the second substrate facing the first substrate, and are made from a transparent material such as ITO (Indium-Tin Oxide), IZO (Indium-Zinc Oxide), or the like. A pixel electrode 251, a common electrode 252 facing the pixel electrode 251, and liquid crystal molecules of the liquid crystal layer sandwiched between the two electrodes 251, 252 cooperatively define a single pixel unit.

The black-inserting circuit 28 includes a polarity control circuit 282, a plurality of transistors 281, and an enable port ON/OFF. The polarity control circuit 282 includes a first output pin B1, a second output pin B2, and two control pins S1, S2. Each transistor 281 includes a source electrode connected to the first output pin B1 or the second output pin B2, a gate electrode connected to the enable port ON/OFF, and a drain electrode connected to one of the signal lines 24. The odd-numbered signal lines 24 (m=1, 3, 5 . . . ) are connected to the first output pin B1 of the polarity control circuit 282 through respective transistors 281. The even-numbered signal lines 24 (m=2, 4, 6 . . . ) are connected to the second output pin B2 of the polarity control circuit 282 through other respective transistors 281. The transistors 281 may be thin film transistors, or any other kind of suitable switch element.

The black-inserting circuit 28 is used to generate a plurality of black-inserting signals. The enable port ON/OFF provides an enable signal for the black-inserting circuit 28 En to activate the transistors 281. When the plurality of transistors 281 are in an activated state, the first output pin B 1 of the polarity control circuit 28 provides the black-inserting signals to the odd-numbered signal lines 24 (1, 3, 5 . . . ) through respective transistors 281, and the second output pin B2 of the polarity control circuit 28 provides the black-inserting signals to the even-numbered signal lines 24 (2, 4, 6 . . . ) through other respective transistors 281. The control pins S1, S2 of the polarity control circuit 282 are used to control the polarity of the black-inserting signals, and apply the black-inserting signals to the signal lines 24 through the first and second output pins B1, B2.

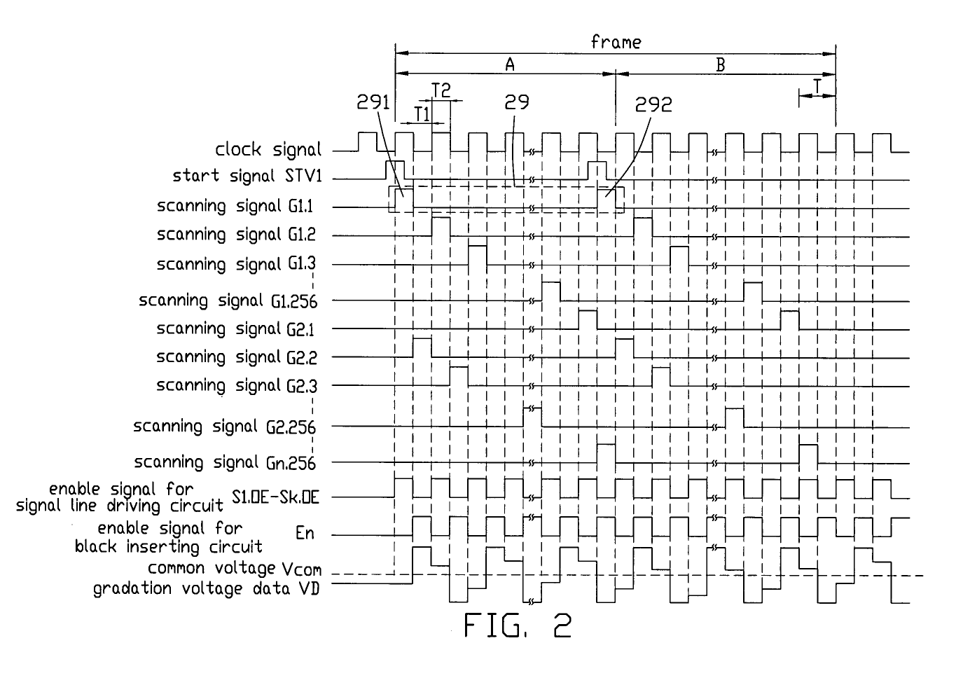

FIG. 2 is an abbreviated timing chart illustrating operation of the active matrix LCD 200. The clock signal and the start signal STV1 are generated by the timing control circuit 26, and the clock signal has a steady period T. The scanning signal groups G1.1-Gn.256 are generated by the plurality of scanning line driving circuits 21, and are applied to the scanning lines 23. The gradation voltage data VD are generated by the plurality of signal line driving circuits 22, and are sequentially applied to the signal lines 24. The common voltage Vcom is applied to all of the common electrodes 252. The enable signal for signal line driving circuit S1.OE-Sk.OE is used to select one of the signal line driving circuits 26 to be in an on state. The enable signal for black-inserting circuit En is used to select the black-inserting circuit 28 to be an on state. Only one of the scanning signal groups 29 is applied to each scanning line 23 during each one scan. The scanning signal groups 29 are output sequentially to the scanning lines 23. Each of the scanning signal groups 29 has a duration equal to a predetermined time, such as half of the frame time. Each of the scanning signal groups 29 includes an image scanning signal 291 having a duration represented by a time period T1, and a black-inserting scanning signal 292 having a duration represented by a time period T2. T1 plus T2 is equal to the clock period T. Both the image scanning signal 291 and the black-inserting scanning signal 292 are pulse signals. In the illustrated embodiment, T1 is equal to T2.

The scanning line driving circuits 21 sequentially apply the scanning signal groups 29 (G1.1 to Gn.256) to the scanning lines 23. When the image scanning signals 291 are provided to the scanning lines 23 by the corresponding scanning line driving circuits 21, the TFTs 25 respectively connected to the scanning lines 23 are activated by the image scanning signals 291. Then the signal line driving circuits 22 provide gradation voltage data (VD) corresponding with image data of an external circuit to the signal lines 24, and the gradation voltage data are written to the pixel electrodes 251 via the activated TFTs 25. The potentials of the common electrodes 252 are set at a uniform potential. The gradation voltage data written to the pixel electrodes 251 are used to control the amount of light transmission of the corresponding pixel units and consequently provide an image display for the active matrix LCD 200. When the black-inserting scanning signals 292 are provided to the scanning lines 23 by the corresponding scanning line driving circuits 21, the TFTs 25 respectively connected to the scanning lines 23 are activated by the black-inserting scanning signals 292. Then the black-inserting circuit 28 provides a high voltage corresponding with black image data to the signal lines 24, and the black image data are written to the pixel electrodes 251 via the activated TFTs 25. The black image data written to the pixel electrodes 251 are used to control the amount of light transmission of the corresponding pixel units and consequently provide a black image display for the active matrix LCD 200.

Unlike in a conventional LCD, the signal lines 24 are connected to the plurality of signal line driving circuits 22 and the black-inserting circuit 28. The signal line driving circuits 22 provide gradation voltage data corresponding to image data to the signal lines 24. After about half of the frame time, the black-inserting circuit 28 provides black-inserting signals corresponding to black image data to the signal lines 24. In this manner, a viewer's eyes perceive the black image during a second half frame time B, and an afterimage of the image displayed in the first half frame time A is lost from the viewer's perception during the second half frame time B. This means that there is no overlap of an afterimage with a perceived image of the next frame period. Thus from the viewpoint of a user, the image quality of the displayed image is clear.

In an alternative embodiment, each of the scanning signal groups 29 has a duration equal to two fifths of the frame time. In other alternative embodiments, the duration of an image scanning signal can be longer than or shorter than the duration of a black-inserting scanning signal.

It is to be understood, however, that even though numerous characteristics and advantages of the preferred embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An active matrix liquid crystal display (LCD), comprising:
a plurality of scanning lines that are parallel to each other and that each extend along a first direction;
a plurality of signal lines that are parallel to each other and that each extend along a second direction orthogonal to the first direction;
a plurality of thin film transistors (TFTs) each provided in the vicinity of a respective point of intersection of the scanning lines and the signal lines;
a plurality of scanning line driving circuits for providing a plurality of scanning signal groups to the scanning lines, each of the scanning signal groups including an image scanning signal and a black-inserting scanning signal;
a plurality of signal line driving circuits for providing gradation voltage data to the signal lines when an image scanning signal is provided to the scanning lines by the scanning line driving circuits; and
a black-inserting circuit for providing black-inserting signals corresponding to black image data to the signal lines when black-inserting scanning signals are provided to the scanning lines by the scanning line driving circuits.

2. The active matrix LCD as claimed in claim 1, wherein the black-inserting circuit includes a plurality of transistors, an enable port providing an enable signal to activate the transistors, and a polarity control circuit providing black-inserting signals to the signal lines through the transistors when the transistors are in an activated state.

3. The active matrix LCD as claimed in claim 2, wherein the polarity control circuit includes two control pins, a first output pin connected to odd-numbered signal lines through respective of the transistors, and a second output pin connected to even-numbered signal lines through respective other of the transistors.

4. The active matrix LCD as claimed in claim 3, wherein the control pins of the polarity circuit are used to control the polarity of the black-inserting signals, and apply the black-inserting signals to the signal lines.

5. The active matrix LCD as claimed in claim 1, further comprising a timing control circuit used to provide clock signals having a steady period.

6. The active matrix LCD as claimed in claim 5, wherein the image scanning signal and the black-inserting scanning signal are pulse signals.

7. The active matrix LCD as claimed in claim 6, wherein a duration of each image scanning signal plus a duration of each black-inserting scanning signal is equal to one clock period.

8. The active matrix LCD as claimed in claim 7, wherein the duration of each image scanning signal is equal to the duration of each black-inserting scanning signal.

9. The active matrix LCD as claimed in claim 7, wherein the duration of each image scanning signal is longer than the duration of each black-inserting scanning signal.

10. The active matrix LCD as claimed in claim 7, wherein the duration of each image scanning signal is shorter than the duration of each black-inserting scanning signal.

11. The active matrix LCD as claimed in claim 1, wherein each of the scanning signal groups has a duration equal to half of a frame time.

12. The active matrix LCD as claimed in claim 1, wherein each of the scanning signal groups has a duration equal to two fifths of a frame time.
